(19) United States
(12) Patent Application Publication
(10) Pub. No.: US 2006/0113785 A1
(43) Pub. Date: Jun. 1, 2006

(54) Seatbelt apparatus and tongue retrieval assisting device

(75) Inventors: Tadashi Sugiyama, Hikone-shi (JP); Masashi Nanbu, Hikone-shi (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/265,507

(22) Filed: Nov. 3, 2005

(30) Foreign Application Priority Data
Nov. 5, 2004 (JP) 2004-322219

(51) Int. Cl. B60R 22/00; B60R 22/18

(52) U.S. Cl. 280/801.1; 280/808; 297/481

(57) ABSTRACT

A seatbelt apparatus installed in a motor vehicle, including a tongue retrieval assisting device to assist the occupant in retrieving a tongue supported by the seatbelt. The tongue retrieval assistance device may include a rod for conveying a tongue to a tongue retrieval position, in which the rod is telescopically and extendably composed of three rod members. Force applied to the rod and an attaching portion of the rod can be suppressed even when an occupant comes into contact with the conveying device.

### BACKGROUND

The present invention relates to a seatbelt apparatus installed in a motor vehicle, such as an automobile. The apparatus may include a tongue retrieval assisting device to assist the occupant in retrieving a tongue supported by the seatbelt and latched with a buckle fixed to a body of a vehicle, or the like.

A conventional three-point-type seatbelt apparatus is shown in FIG. 11. As shown in FIG. 11, a seatbelt apparatus 1 is installed in a motor vehicle seat 2. A seatbelt retractor 3 is fixed to a body of a vehicle adjacent to the motor vehicle seat 2, for withdrawably retracting the seatbelt 4 in normal time and does not allow the seatbelt 4 to be withdrawn in an emergency. A tongue 5 is slidably supported by the seatbelt 4. A buckle 6 is fixed to the motor vehicle seat 2 or a body of a vehicle, with which the tongue 5 is latched. A belt guide 7 is attached to an upper part of a side portion of the motor vehicle, such as a center pillar 8 or the like. The belt guide 7 guides the seatbelt 4 when the seatbelt webbing is withdrawn from the seatbelt retractor 3. In addition, a belt anchor portion 4a of the tip end of the seatbelt 4 is fixed to the motor vehicle seat 2 or a body of the vehicle.

In the exemplary seatbelt apparatus 1 shown in FIG. 11, when the occupant wears the seatbelt 4, the occupant withdraws the seatbelt 4 from the seatbelt retractor 3, and takes his/her hand off from the tongue 5 after latching the tongue 5 with the buckle 6. Any excess portion of the seatbelt webbing is then retracted by the seatbelt retractor 3 and any slack in the seatbelt 4 is eliminated.

In such a seatbelt apparatus 1, the seatbelt 4 is retracted by the seatbelt retractor 3 with almost no slack when the seatbelt 4 is not worn by the occupant. Accordingly, the seatbelt 4 extending between the belt guide 7 and the belt anchor portion 4a of the seatbelt 4 is positioned nearly along the center pillar 8. Therefore, the tongue 5 supported by the seatbelt 4 is positioned adjacent to the center pillar 8.

However, when the tongue 5 is thus positioned, and when the seatbelt 4 is not worn by the occupant while the occupant is seated on the motor vehicle seat 2, the tongue 5 is positioned at a side of, and behind the occupant. As a result, when the occupant seated on the motor vehicle seat 2 tries to take the tongue 5 by hand to wear the seatbelt 4, the occupant must inconveniently look behind and be forced to take the tongue 5 from an unstable posture. Consequently, the tongue 5 is difficult to be retrieved and a handling operation for the tongue 5 to latch with the buckle 6 is bothersome.

In consideration of the problem mentioned above, a seatbelt presenter apparatus is proposed in, for example, Publication of Japanese Registered Utility Model No. 61-176047 (incorporated by reference herein). In the seatbelt presenter apparatus proposed by Japanese Registered Utility Model No. 61-176047, an occupant seated on a motor vehicle is enabled to easily take out a tongue and is enabled to simplify the handling operation of the tongue, when the occupant wears the seatbelt.

The seatbelt presenter disclosed in Japanese Registered Utility Model No. 61-176047 includes a telescopic-type rod which is retractably provided thereto, a belt hanger portion formed such that a webbing is loosely fit to a tip end of the rod, and a motor to retract the rod. Further, when the occupant takes a ride in a motor vehicle and turns on an ignition switch after closing a door, the rod is extended by a rotation of the motor and the belt hanger portion is protruded forward. As a result, the seat belt loosely fit at the belt hanger portion is also advanced forward and the tongue supported by the seatbelt is thereby guided toward a position within the reach of the occupant. When the occupant takes out the tongue by hand and inserts the tongue into a buckle, or even when the occupant does not take out the tongue, the motor is rotated in a reverse direction and the rod is retracted when a predetermined time has elapsed after the belt hanger portion has protruded forward.

However, in the seatbelt presenter disclosed in Japanese Registered Utility Model No. 61-176047, when the rod is extended and the belt hanger portion is protruded forward, because the extended rod is positioned at the side of, and adjacent to the occupant, it is possible that the occupant comes into contact with the rod and a relatively large force is applied to the rod itself and an attaching portion of the rod.

### SUMMARY OF THE INVENTION

According to an embodiment of the present invention, a tongue retrieval assisting device for conveying a tongue slidably supported by a seatbelt between a tongue storage position and a tongue retrieval position set in front of an occupant seated on a motor vehicle seat includes a tongue receiving member for supporting a tongue, a conveying device for conveying the tongue receiving member and tongue between the tongue retrieval position and the tongue storage position, wherein the conveying device is attached to the seat with an elastic mount so that forces exerted upon the tongue retrieval assisting device are buffered.

According to an embodiment of the present invention, a seatbelt apparatus includes a seatbelt for an occupant of a seat, a seatbelt retractor mounted on a motor vehicle for urging the seatbelt in a direction for retracting the seatbelt, a tongue that is slidably supported by the seatbelt, and a buckle mounted on the motor vehicle that is latched when the tongue inserted thereinto, wherein, the seatbelt apparatus further includes the tongue retrieval assisting device for conveying the tongue between a tongue storage position and a tongue retrieval position set in front of the occupant seated on the seat, wherein the tongue retrieval assisting device includes a tongue receiving member for supporting the tongue, a conveying device for conveying the tongue receiving member and tongue between the tongue retrieval position and the tongue storage position, wherein the conveying device is attached to the seat with an elastic mount so that forces exerted upon the tongue retrieval assisting device are buffered.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1(a) is a schematic view from the left of a motor vehicle seat with a tongue retrieval assisting device according to an embodiment of the present invention.

FIG. 1(b) is a schematic view from the front of a motor vehicle seat with a tongue retrieval assisting device according to an embodiment of the present invention.

FIG. 1(c) is a schematic view from below of a motor vehicle seat with a tongue retrieval assisting device according to an embodiment of the present invention.

FIG. 2(a) is an enlarged view from the left of the tongue retrieval assisting devices of FIGS. 1(a) through 1(c) showing a rod in a state of being retracted, according to an embodiment of the present invention.

FIG. 2(b) is an enlarged view from the left of the tongue retrieval assisting devices of FIGS. 1(a) through 1(c) showing a rod in a state of being extended, according to an embodiment of the present invention.

FIG. 3(a) is an illustration showing a tongue receiving portion in a state being attached to the rod of the embodiment shown in FIGS. 1(a) through 1(c).

FIG. 3(b) is a plan view showing the tongue receiving portion, according to an embodiment of the present invention.

FIG. 3(c) is a side view showing the tongue receiving portion, according to an embodiment of the present invention.

FIG. 3(d) shows the tongue engagement portion, according to an embodiment of the present invention.

FIG. 4 is a perspective view illustrating a rod attached by rubber-mounts, according to an embodiment of the present invention.

FIG. 5 is a view explaining a process of a tongue receiving plate receiving the tongue, according to an embodiment of the present invention.

FIG. 6 is a flowchart explaining a motor control of the tongue retrieval system in an embodiment, according to an embodiment of the present invention.

FIG. 7 is a flowchart explaining a motor control of the tongue retrieval system in another embodiment of the present invention.

FIG. 8 is a perspective view partially showing a tongue retrieval assisting device according to another embodiment of the present invention.

FIG. 9 is a perspective view showing the tongue receiving portion of the embodiment shown in FIG. 8.

FIG. 10(a) is a cross-sectional view of a gripping portion of the tongue mounted on the tongue receiving portion of the embodiment shown in FIG. 9.

FIG. 10(b) shows the view of the gripping portion of FIG. 10(a) engaged with a tongue receiving plate.

FIG. 11 is an illustration showing a conventional and commonly used three-point-type seatbelt apparatus.

### DETAILED DESCRIPTION

Embodiments of the present invention will be described below with reference to the drawings.

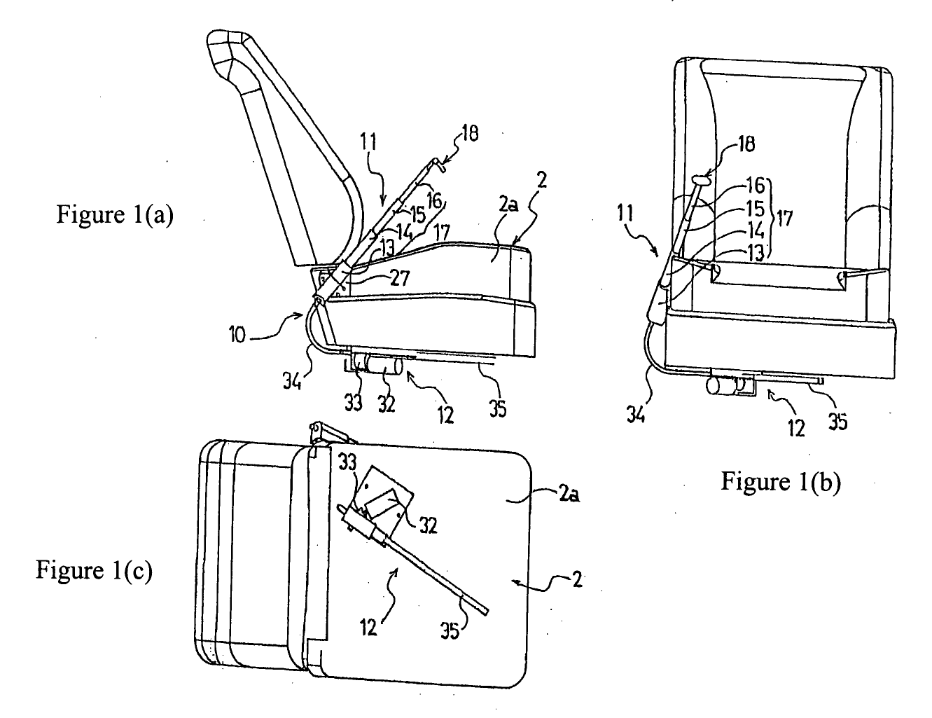

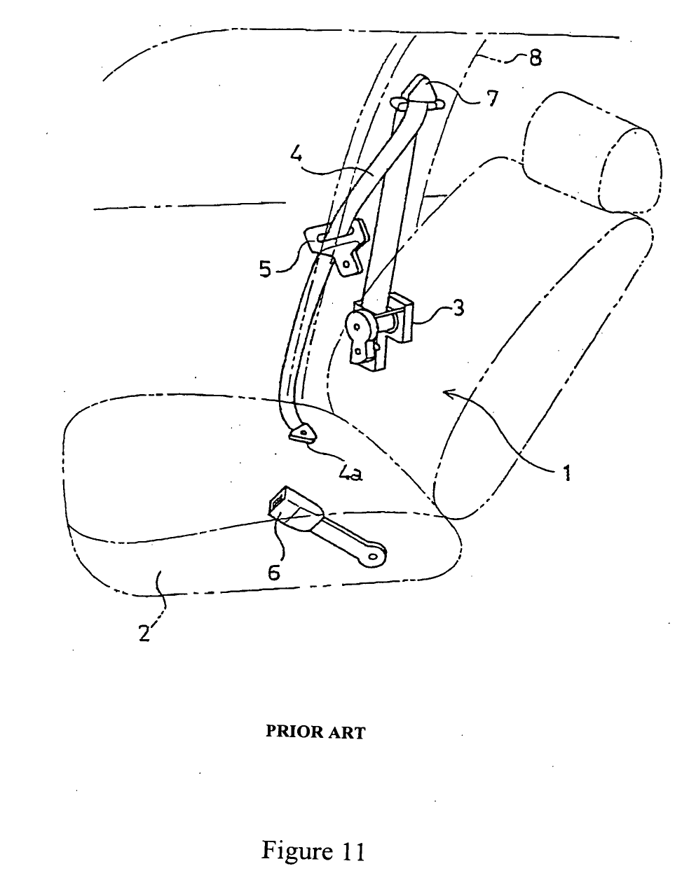

FIGS. 1(a) through 1(c) schematically illustrate an embodiment of an entire tongue retrieval assisting device with respect to the present invention. Further, in an explanation of each of the embodiments described below, the same numerals denote the same element in the embodiment explained earlier, and the same numerals denote the same element in the related art, shown in FIG. 11, described earlier, and the detailed explanation is thereby omitted.

As illustrated in FIGS. 1(a) through 1(c), the tongue retrieval assisting device 10 in this embodiment may be provided with a tongue conveying device or section 11 disposed at the motor vehicle seat 2 at the left side, which conveys a tongue 5 to a tongue retrieval position, and a drive section 12 that operates the tongue conveying section 11.

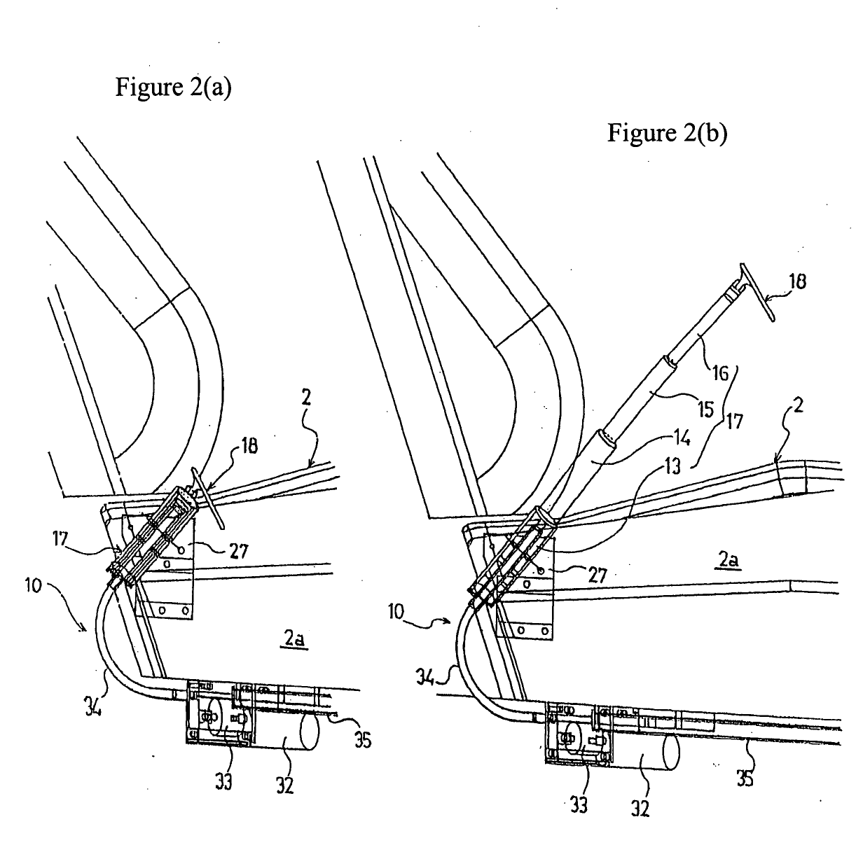

As illustrated in FIGS. 2(a) and 2(b), the tongue conveying section 11 may be provided with a transfer device such as, for example, a rod 17, retractably composed of four cylindrical rod members 13, 14, 15, and 16 in a telescopic structure and a tongue receiving member 18 provided at a tip end of the rod member 16 that has the smallest diameter of the four cylindrical rod members.

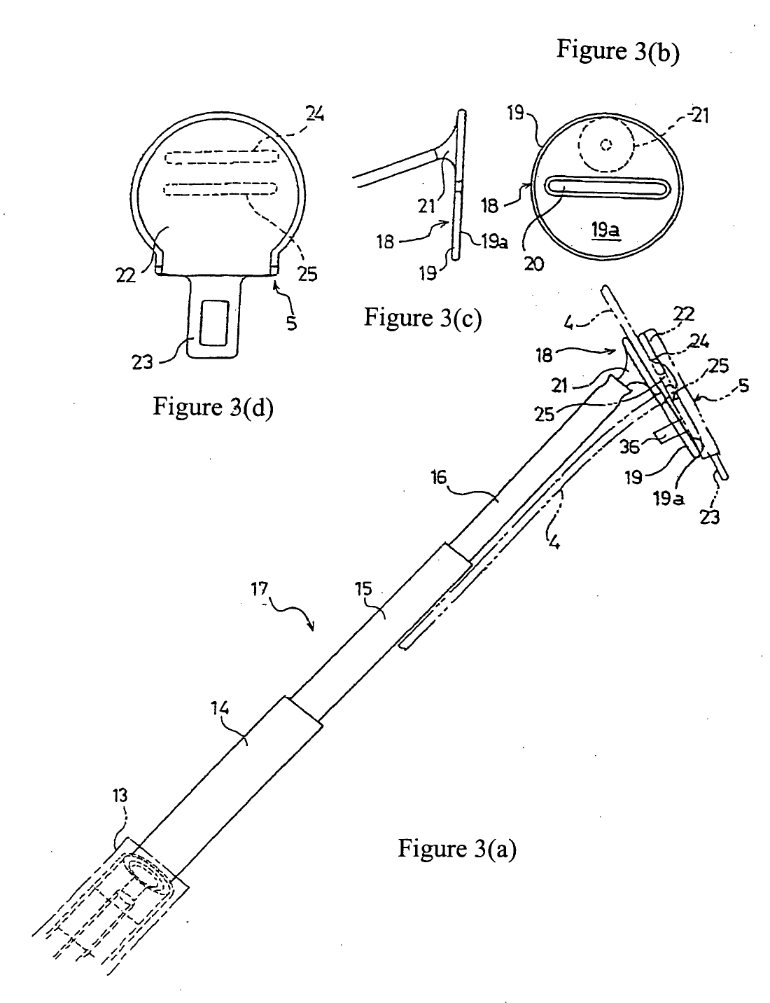

As shown in FIGS. 3(a) through 3(c), the tongue receiving member 18 may include a tongue receiving plate 19 that has a shape of an approximately circular disc and the tongue 5 may be mounted on a tongue receiving face 19a of the tongue receiving plate 19 and conveyed to the tongue retrieval position. At a center of the tongue receiving plate 19, an elongated penetration hole 20 extending to a radial direction may be formed, such as by drilling, and a seatbelt 4 may be slidably placed in the penetration hole 20. At a face opposite to the tongue receiving face 19a of the tongue receiving plate 19, an attaching portion 21 may be provided at an eccentric position in the face and may be attached to a tip end of the rod member 16. In this case, the tongue receiving plate 19 may be configured to extend downward from the attaching portion 21.

The tongue 5 mounted on the tongue receiving plate 19 may include a gripping portion 22 to be gripped by an occupant by hand, which is an arc-shaped plate having a diameter slightly larger than that of the tongue receiving plate 19. The plate 19 may also include a latching portion 23 that is projected from the gripping portion 22 and inserted and latched with the buckle 6, as shown in FIG. 3(d). In the gripping portion 22, a pair of holes 24 and 25 extending in the radial direction, positioned in parallel with each other and forming a link with each other at an opposite end of the gripping portion 22 from the latching portion 23, as shown in FIG. 3(d). The holes may be formed, by drilling, for example. The seatbelt 4, lowered from a belt guide 7 may be inserted into the hole 24 formed at a position farther from the latching portion 23 and withdrawn through the elongated hole 25 that is formed at a position closer to the latching portion 23, and is slidably inserted into the tongue 5.

In addition, as illustrated in FIG. 3(a) by a two-dot chain line, the gripping portion 22 of the tongue 5 may be mounted on the tongue receiving plate 19 so that the latching portion 23 is directed downward. The part of the gripping portion 22 between the pair of holes 24 and 25 is pressed to the tongue receiving plate 19 by a belt retracting force caused by a seatbelt retractor 3. Thereby, mounting for the gripping portion 22 to the tongue receiving plate 19 is stably operated. In addition, because the tongue receiving plate 19 has a relatively wide flat face, a mounting operation of the tongue 5 onto the tongue receiving member 18 may be stabilized.

Further, because a diameter of the tongue receiving plate 19 may be set slightly smaller than the diameter of the gripping portion 22 of the tongue 5, the outer dimension of the tongue receiving plate 19 may be smaller than that of the gripping portion 22. As a result, when the gripping portion 22 of the tongue 5 is mounted on the tongue receiving plate 19, a peripheral edge of the gripping portion 22 of the tongue 5 protrudes outward from that of the tongue receiving plate 19. When the occupant grips the gripping portion 22 of the tongue 5 by hand, the occupant is not likely to grasp the tongue receiving plate 19 together with the gripping portion 22.

The rod 17, which may include four cylindrical rods 13, 14, 15, and 16, may employ telescopic structure known in the art. The rod 17 can be set to a retracted state, shown in FIG. 2(a) and an extended state, shown in FIG. 2(b). In the retracted state of the rod 17, the tongue receiving member 18 may be positioned at a storing position at the left side behind the motor vehicle seat 2 so that the tongue receiving member 18 and the rod 17 do not disturb an occupant that is getting in or out of the motor vehicle. In the extended state of the rod 17, the tongue receiving member 18 may be positioned to a slightly inner side of the motor vehicle seat 2, as illustrated in FIG. 1(b). The tongue receiving member 18 in the extended state of the rod 17 may be positioned in front of the chest or the waist of the occupant seated on the motor vehicle seat 2. When the rod 17 is extended the occupant can take out the tongue 5 mounted on the tongue receiving member 18 at the tongue retrieval position by hand with ease. Further, the number of the rod members is not limited to four and may be appropriately determined.

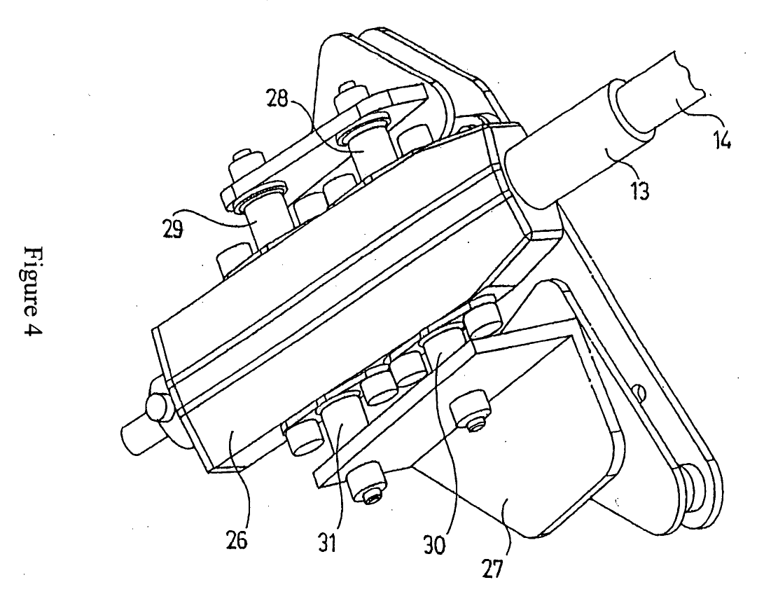

As illustrated in FIG. 4, the rod member 13 having the largest diameter may be attached to an attaching bracket 26. The attaching bracket 26 may be elastically attached to an attaching bracket 27 on the motor vehicle seat side through four rubber-mounts 28, 29, 30, and 31. The attaching bracket 27 may be attached to the left side of the rear part of the motor vehicle seat 2, as illustrated in FIGS. 1(a), 2(a) and 2(b). The attaching bracket 26 and the attaching bracket 27 are attached to the motor vehicle seat 2, so that when the rod 17 is extended, the tongue receiving member 18 comes to the tongue retrieval position described above.

Further, because the rod 17 may be elastically supported by the four rubber-mounts 28, 29, 30, and 31, force applied to the rod 17, the tongue receiving member 18, and the attaching portion of the rod 17 may be buffered. Thus, a relatively large force does not affect these elements even when a force (e.g., occupant contact) is applied to the rod 17 or the tongue receiving member 18 when the rod 17 is extended. Force on the rod 17, member 18, or both is buffered by the four rubber-mounts 28, 29, 30, and 31 regardless of the direction from which the force is applied. For example, a typical force considered to be most frequently applied is applied to the rod 17 or the tongue receiving member 18 from inside of the motor vehicle seat 2. This typical force is buffered by the rubber mounts.

Further, in the seatbelt apparatus according to the embodiment of the present invention, by applying the tongue retrieval assisting device to the seatbelt apparatus, the force applied to the conveying device can be reduced by the elastic mount even when external force is applied to the conveying device. Thus, there is no particular problem caused by an occupant's touch on the conveying device when the occupant is performing inserting-and-latching operation between the tongue and the buckle, thereby allowing to wear the seatbelt easily.

As illustrated in FIGS. 1(a) through 1(c), and FIGS. 2(a) and 2(b), the drive section 12 is provided at a lower part of the motor vehicle seat 2. The drive section 12 is provided with a motor 32 attached to a lower part of the seat cushion 2a in the motor vehicle seat 2 and a drive gear 33 to which rotation drive force of the motor 32 is transmitted with reduced speed. The drive section 12 also includes a flexible rod extension/retraction cable 34 , which is connected to the rod member 16 having the smallest diameter passing through inside the four rod members 13, 14, 15, and 16. The cable 34 has teeth (not shown)constantly engaged with the drive gear 33. The drive section 12 further includes a cable guide 35 for guiding the rod extension/retraction cable 34 extendably provided in a slanting manner from a left side of the rear part to a right side of the front part of a lower face of the seat cushion 2a of the motor vehicle seat 2. A known power transmission structure can be used for the power transmission structure in which the rotation drive force of the motor 32 is applied to the rod extension/retraction cable 34.

When the motor 32 is rotated in a direction in which the cable 34 is deployed out to a rod 17 side, the rod 17 extends in a telescopic fashion. On the contrary, when the motor 32 is rotated in a direction in which the cable 34 is retracted toward a cable guide 35 side, the rod 17 is retracted in a telescopic fashion.

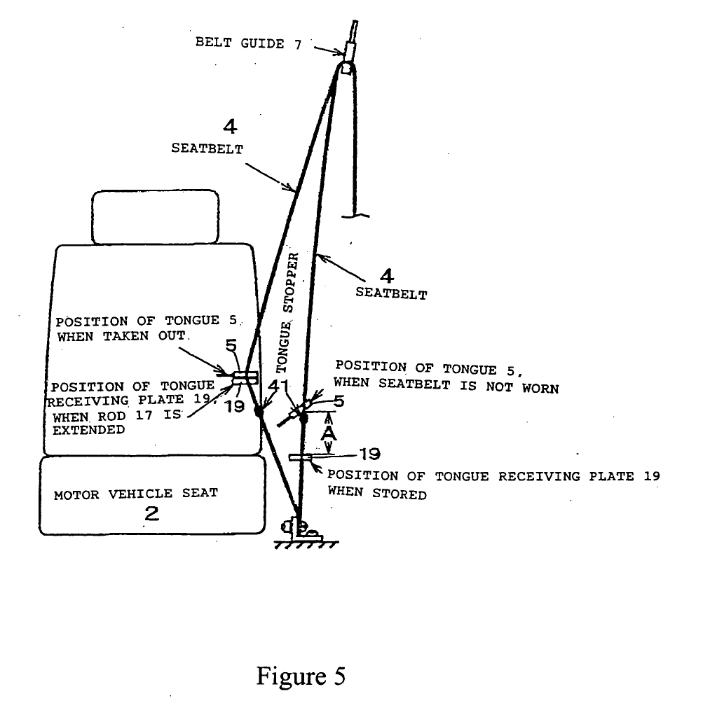

As illustrated in FIG. 5, when the seatbelt 4 is not worn, the tongue 5 contacts a tongue stopper 41 and is stopped, i.e., the tongue 5 is not lowered further, similar to the case in a conventional seatbelt apparatus. When the tongue retrieval assisting device 10 is not in operation, the tongue receiving plate 19 is at the storing position. A distance A between the position of the tongue 5 when the seatbelt 4 is not worn, and the position of the tongue receiving plate 19 at the storing position is less than the extending amount of the rod 17. In other words, the distance between the tongue receiving plate 19 at the storing position and the tongue receiving plate 19 at the tongue retrieval position is greater than the distance A. Thereby, when the rod 17 is extended together with the operation of the tongue retrieval assisting device 10, the tongue 5 can be assuredly received by the tongue receiving plate 19. In this case, the size of the penetration hole 20 of the tongue receiving plate 19 is set such that the tongue stopper 41 is able to smoothly pass through the penetration hole 20 while the rod 17 is extended.

When the rod 17 is extended so that the tongue receiving member 18 is transferred from the storing position to the tongue retrieval position, the tongue receiving plate 19 of the tongue receiving member 18 conveys the tongue mounted thereupon to the tongue retrieval position.

Thus, in accordance with the tongue retrieval assisting device 10 of this embodiment, when the tongue receiving member 18 is transferred from the storing position to the tongue retrieval position for the seatbelt 4 to be worn by the occupant, the tongue 5 is conveyed to the tongue retrieval position by the tongue receiving member 18. As a result, the occupant seated on the motor vehicle seat 2 can take out the tongue 5 by hand with ease. Therefore, at a time when the seatbelt 4 is worn, ease of handling of the tongue 5 by the occupant can be sufficiently improved and the tongue can be assuredly retrieved.

Further, when the passenger is seated on the motor vehicle seat 2 earlier than the driver and tries to wear the seatbelt 4, the tongue 5 can be assuredly conveyed to the tongue retrieval position by setting the tongue receiving member 18 to the tongue retrieval position. Accordingly, in comparison with the case described in Japanese Registered Utility Model No. 61-176047, ease of handling of the tongue 5 by the passenger can be improved and assuredness of retrieval operation of the tongue by the passenger can also be improved.

Furthermore, because the outer shape of the tongue receiving plate 19 of the tongue receiving member 18 is made smaller than that of the gripping portion 22 of the tongue 5, the peripheral edge of the gripping portion 22 of the tongue 5 outwardly projects from the peripheral edge of the tongue receiving plate 19 when the gripping portion 22 of the tongue 5 is mounted on the tongue receiving plate 19. As a result, the occupant can grip the gripping portion 22 by hand without gripping the tongue receiving plate 19 together when the occupant grips the gripping portion 22 of the tongue 5. Accordingly, the tongue 5 can be further easily and assuredly retrieved.

Moreover, because the rod 17 is elastically supported by four rubber-mounts 28, 29, 30, and 31, even when external force is applied to these rods or the tongue receiving member 18 resulting from the occupant coming into contact with the rod 17, or the tongue receiving member 18, or the like, the force applied to the rod 17, tongue receiving member 18, and the attaching portion of the rod 17 can be reduced by the rubber-mounts 28, 29, 30, and 31.

Furthermore, because the tongue retrieval assisting device 10 is attached to the motor vehicle seat 2, even when the position of the motor vehicle seat 2 is adjusted in the back-and-front direction by the occupant, the tongue retrieval assisting device 10 is moved together with the back-and-front movement of the motor vehicle seat 2. Therefore, the tongue retrieval position relative to the motor vehicle seat 2 is not changed and the tongue retrieval position relative to the occupant seated on the motor vehicle seat 2 is kept approximately constant.

Further, because ease of inserting and latching for the tongue 5 with the buckle 6 is improved by applying the tongue retrieval assisting device 10 of this embodiment to the seatbelt apparatus, the seatbelt 4 can be thereby easily worn by the occupant. In addition, according to the seatbelt apparatus, even when external force is applied to the rod 17 due to an occupant's touch on the conveying device or the like, the force applied to the rod 17 can be reduced by four rubber mounts 28, 29, 30, 31, and therefore, any particular problem is not caused, even when the occupant comes into contact with the rod 17 when the occupant is performing inserting-and-latching operation between the tongue and the buckle. That is, the seatbelt 4 can be thereby more easily worn by the occupant.

Meanwhile, in the tongue retrieval assisting device 10 of this embodiment, a tongue retrieval system is configured such that the tongue receiving member 18 is automatically set to the tongue retrieval position and the storing position by extending or retracting the rod 17 by controlling the rotation of the motor 32 with an electronic controller (not shown).

In the tongue retrieval system of this embodiment, a tongue retrieval sensor 36 that detects that the tongue 5 is retrieved from the tongue receiving member 18 by the occupant and outputs a tongue retrieval signal, is provided in the tongue receiving member 18, as illustrated in FIG. 3(a). The signal may be provided to the controller mentioned above so that the rod may be retracted automatically.

Further, although not shown, a seating sensor for detecting that the occupant is seated on the motor vehicle seat 2 is provided in the motor vehicle seat 2 and a door sensor for detecting opening or closing of the door is provided in the door. In addition, when the rod 17 is fully extended, the tongue receiving member 18 exists at the tongue retrieval position and when the rod 17 is fully retracted, the tongue receiving member 18 exists at the storing position. Further, a rod full extension sensor for detecting the maximum extension of the rod 17, and a rod full retraction sensor for detecting that the rod 17 is retracted to have smallest length are provided in the rod 17. For these sensors, heretofore sensors known in the art can be used and a detailed explanation is omitted.

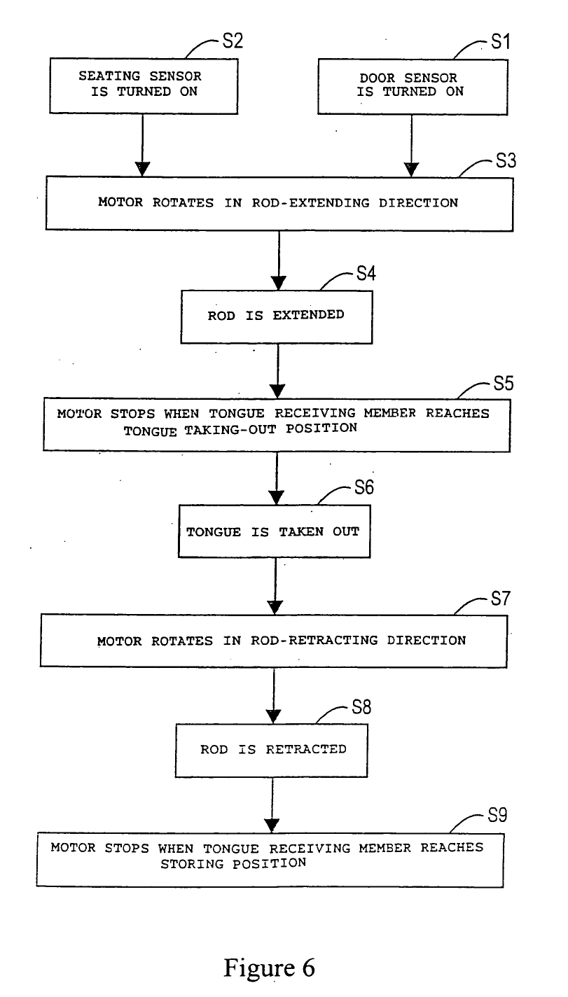

Furthermore, in the tongue retrieval system of this embodiment, the tongue receiving member 18 is automatically set at the tongue retrieval position or the storing position when a controller controls the drive of the motor 32 according to a flowchart showing the control of the motor drive, as illustrated in FIG. 6.

That is, as illustrated in FIG. 6, according to a door closing signal from the door sensor indicating that the door is closed in Step S1, and the seating signal from the seating sensor indicating that the occupant is seated in Step S2, the controller controls the motor 32 to rotate in a direction in which the rod 17 is extended in Step S3. Then, the rod is extended in Step S4. The motor 32 is stopped by the controller on the basis of the rod full extension signal from the rod full extension sensor, indicating that the rod 17 is extended to the maximum and the tongue receiving member 18 reaches the tongue retrieval position in Step S5. Thereafter, the tongue 5 conveyed to the tongue retrieval position by the tongue receiving member 18 is retrieved by the occupant in Step S6, and the controller controls the motor 32 to rotate in a reverse direction, namely in a direction for retracting the rod 17, on the basis of the tongue retrieval signal output from the tongue retrieval sensor 36 in Step S7. Then, the rod 17 is retracted in Step S8. The controller stops rotation of the motor 32 on the basis of a rod full retraction signal from the rod full retraction sensor, indicating that the rod 17 has retracted to have shortest length and the tongue receiving member 18 has reached the storing position in Step S9.

According to the tongue retrieval system of this embodiment, the rod 17 is retracted when the tongue 5 is retrieved from the tongue receiving member 18 by the occupant. Therefore, at a time when the tongue is inserted and latched with the buckle 6, the rod 17 is retracted and the tongue receiving member 18 is positioned at the storing position or the position adjacent to the storing position. Accordingly, when the occupant has completed latching the tongue 5 with the buckle 6 and takes off a hand from the seatbelt 4 and the tongue 5, the seatbelt 4 can be adjusted to properly tighten the occupant and thereby preventing the occupant from sensing the discomfort.

Further, unless the occupant assuredly takes out the tongue 5 from the tongue receiving member 18, the tongue receiving member 18 is not transferred to the storing position behind the motor vehicle seat 2. By the aforementioned configuration, ease of handling of the tongue 5 performed by the occupant can be further improved and assuredness of retrieval operation of the tongue 5 performed by the occupant can be improved.

Furthermore, because the rod 17 starts to extend on the basis of two signals of the door-close signal from the door sensor and the seating signal from the seating sensor, the rod 17 can start to extend only when the occupant is seated on the motor vehicle seat 2 and the door is closed. Thereby, even when the door is opened and closed while the occupant is not seated on the motor vehicle seat 2, the rod 17 can be prevented from being extended, and even when the occupant seated on the motor vehicle seat 2 changes own seating posture (driving posture or riding posture) to take something or the like, while the door is closed, the rod 17 can be also prevented from extending, resulting in prevention of needless extension of the rod 17.

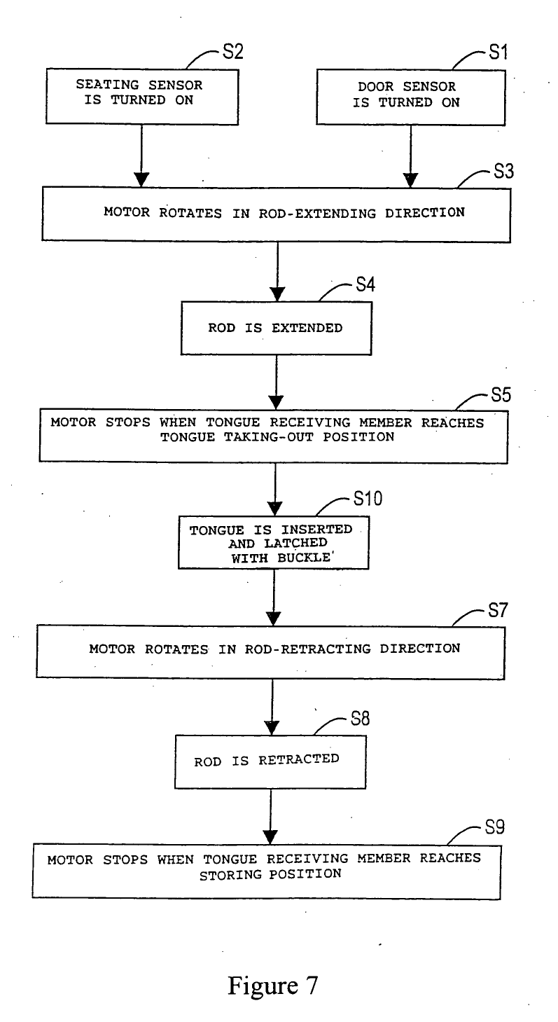

FIG. 7 is a flowchart showing a control of the motor drive of the tongue retrieval system of another embodiment.

In the above-described flowchart illustrated in FIG. 6, the controller controls the motor 32 to rotate in the direction for retracting the rod 17 by the tongue retrieval signal from the tongue retrieval sensor 36 indicating that the tongue 5 is retrieved from the tongue receiving member 18. However, in the tongue retrieval system of this embodiment, a buckle switch (not shown), instead of the tongue retrieval sensor 36, is used as illustrated in FIG. 7. The buckle switch detects that the tongue 5 is inserted and latched with the buckle 6 and outputs the tongue latching signal. As for the buckle switch, a known buckle switch can be used and the detailed explanation is therefore omitted.

That is, similar to the above-described embodiment shown in FIG. 6, the tongue receiving member 18 reaches the tongue retrieval position and the motor 32 is stopped, in Step S5. Thereafter, the tongue 5 mounted on the tongue receiving member 18 is conveyed to the tongue retrieval position and the tongue 5 retrieved by the occupant is inserted and latched with the buckle 6, in Step S10. Then, the buckle switch detects that the tongue 5 is inserted and latched with the buckle 6 and outputs a tongue latching signal. The controller controls to rotate the motor 32 in a direction for retracting the rod 17, on the basis of the tongue latching signal from the buckle switch in Step S7, in the same manner as the above-mentioned embodiment shown in FIG. 6.

The other steps in the motor drive control as described in FIG. 7 in this embodiment are the same as the above-described embodiment, shown in FIG. 6.

In the tongue retrieval system in this embodiment, the tongue receiving member 18 is kept at the tongue retrieval position until the tongue 5 is inserted and latched with the buckle 6. Accordingly, the tongue receiving member 18 is not yet transferred to the storing position even when the tongue 5 is retrieved from the tongue receiving member 18 by the occupant. The effect from S6 in FIG. 6 is not obtained. However, the other effects are the same as that shown in FIG. 6.

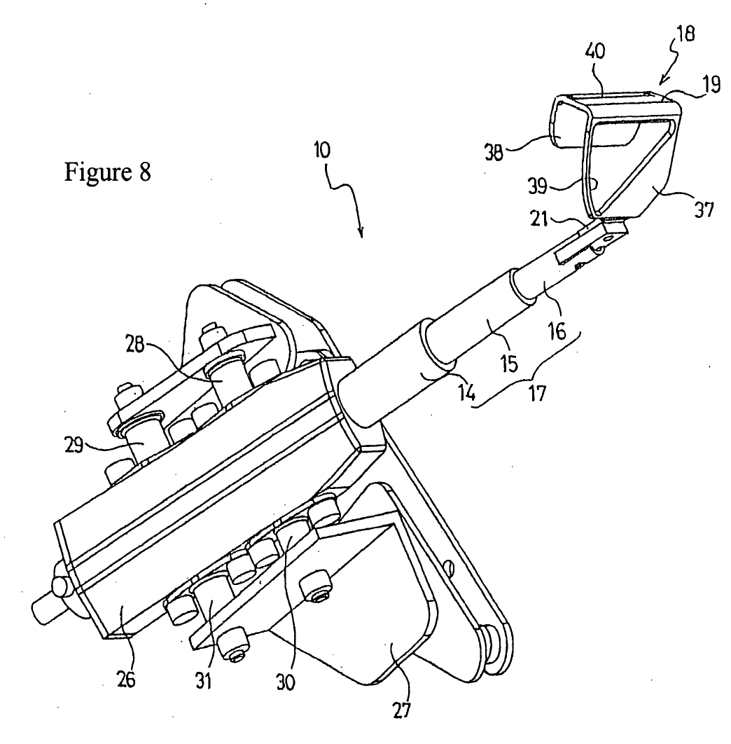

FIG. 8 is a perspective view partially illustrating another embodiment of the tongue retrieval assisting device of the present invention.

In the above-described embodiment, the telescopically retractable rod 17 may be composed of the four rod members 13, 14, 15, and 16. However, in the tongue retrieval assisting device 10 of this embodiment shown in FIG. 8, the rod 17 may be composed of three rod members 14, 15, and 16 in a telescopically retractable fashion. The rod 14 having the largest diameter is attached to the attaching bracket 26 of the rod side.

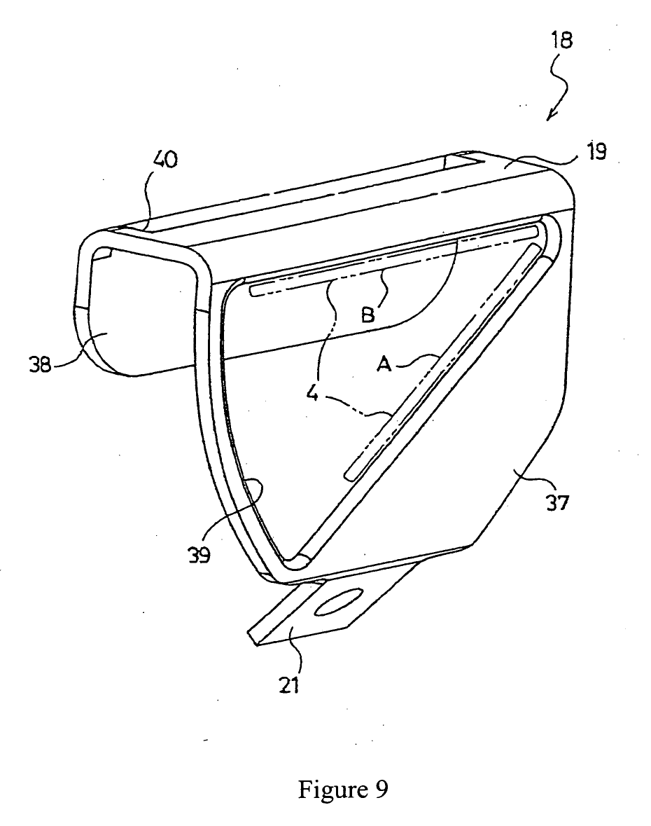

Further, in the above-described embodiment, as illustrated in FIGS. 3(a) through 3(c), the tongue receiving member 18 may be provided with a tongue receiving plate 19 having an approximately circular shape. However, as illustrated in FIG. 8, in the tongue retrieval assisting device of this embodiment, the tongue receiving member 18 of this embodiment may have an approximately U-shape, when seen from the side. The tongue receiving member 18 may be composed of a long side wall 37 having a relatively large length, a short side wall 38 having a relatively small length, and a tongue receiving plate 19 having a flat and an approximately rectangular shape for joining the side walls 37 and 38, which are formed together into an approximately U-shape, as illustrated in FIG. 9.

The long side wall 37 may be provided with an attaching portion 21 at a lower part thereof, and similar to the above-described embodiment, the attaching portion 21 may be attached to a tip end of the rod member 16 having the smallest diameter. In addition, at the lower end of the long side wall, a penetration hole 39 with a relatively large sectorial shape may be formed so that the seatbelt 4 may be slidably penetrated therein. When the tongue receiving member 18 is transferred from the storing position to the tongue retrieval position, the seatbelt 4 penetrates the penetration hole 39 from with its face in an inclined state shown by a mark A, to in an approximately horizontal state shown by a mark B. On the other hand, when the tongue receiving member 18 is transferred from the tongue retrieval position to the storing position, the seatbelt 4 is penetrating the penetration hole 39 from with its face in an approximately horizontal state shown by a mark B, to in an inclined state shown by a mark A. Therefore, at the time when the tongue receiving member 18 is transferred, the inclination of the face of the seatbelt 4 can be smoothly changed by thus forming the penetration hole 39 into the sectorial shape.

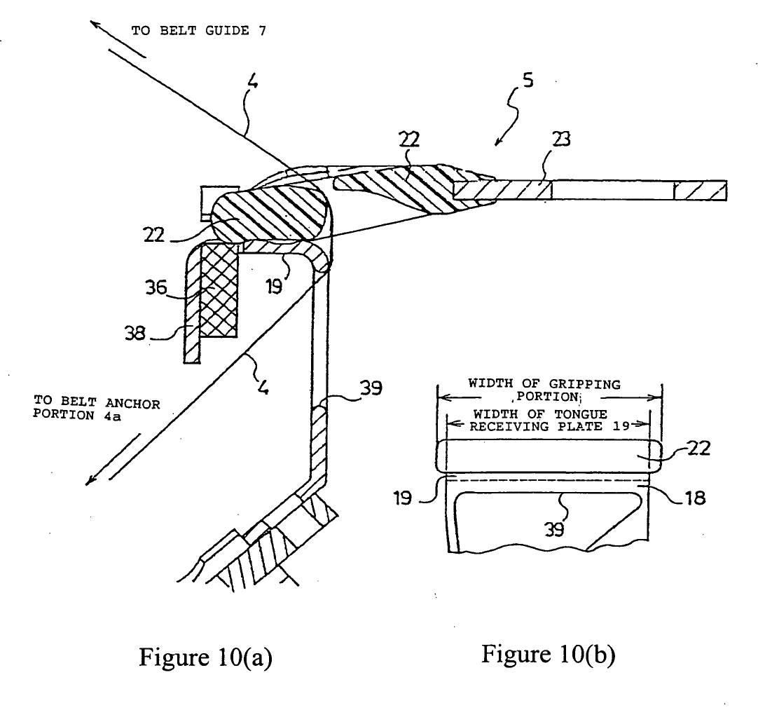

The width (the length in a belt-width direction) of the tongue receiving plate 19 having a rectangular shape may be set smaller than the width (the length in a belt-width direction) of the gripping portion 22. Therefore, as illustrated in FIG. 10(a), in a state that the tongue receiving member 18 is set at the tongue retrieval position and the gripping portion 22 of the tongue 5 is mounted on the tongue receiving plate 19a, as illustrated in FIG. 10(a), a left-and-right edge of the gripping portion 22 is projected onto the outside of the left-and-right edge of the tongue receiving plate 19, as illustrated in FIG. 10(b). As a result, similar to the above-described embodiment, when the occupant grips the gripping portion 22 of the tongue 5, the tongue receiving plate 19 is prevented from being gripped together with the gripping portion 22.

Furthermore, when the gripping portion 22 of the tongue 5 is mounted on the tongue receiving plate 19 shown in FIG. 10(a), the gripping portion 22 is pressed to the relatively wide and flat tongue receiving face 19a of the tongue receiving plate 19 by belt-retracting force of the seatbelt retractor 3. Accordingly, similar to the above-described embodiment, the gripping portion 22 is assuredly mounted onto the tongue receiving plate 19 and the tongue 5 is stably mounted onto the tongue receiving member 18.

In the tongue receiving plate 19, an attaching hole 40 may be formed in the tongue receiving plate 19, such as by drilling or machining. The attaching hole 40 may have a rectangular shape and penetrate the tongue receiving plate 19 from above to below. As illustrated in FIG. 10(a), a tongue retrieval sensor 36 may be mounted in the attaching hole 40. In a state that the tongue receiving member 18 is set to the tongue retrieval position, whereas the tongue 5 is not retrieved by the occupant yet and is mounted on the tongue receiving plate 19 of the tongue receiving member 18, the gripping portion 22 of the tongue 5 is in contact with the tongue retrieval sensor 36, and the tongue retrieval sensor 36 does not output the tongue retrieval signal. When the tongue 5 is retrieved by the occupant, because the gripping portion 22 is released from the tongue retrieval sensor 36, the tongue retrieval sensor 36 outputs the tongue retrieval signal.

The gripping portion of the tongue may have a conventional and well known rectangular shape which may be effectively mounted on the rectangular shape of the tongue receiving plate 19. It is not necessary to form the gripping portion 22 of the tongue 5 into a special shape and, thus, the tongue receiving plate 19 is applicable for a commonly used tongue.

The other configurations and effects of this embodiment are the same as that of the above-described embodiment. In addition, the other configurations and effects of the seatbelt apparatus using the tongue retrieval assisting device 10 of this embodiment are the same as that of the above-described embodiment.

Furthermore, the tongue retrieval sensor 36 or the buckle switch for detecting the retrieval operation of the tongue, which are used in each of the above-described embodiments as an output device for outputting a trigger signal so as to rotate the motor 32 in the direction for retracting the extended rod 17, is not always necessary to be provided and may be omitted. In this case, the rotation of the motor can be started by manual switching. However, in consideration of ease of handling of the tongue 5 or wearability for the seatbelt 4, it is preferable to automatically transfer the tongue receiving member 18 between the storing position and the tongue retrieval position as mentioned in each of the above-described embodiments.

Furthermore, both the elongated penetration hole 20 for slidably penetrating the seatbelt 4, shown in FIG. 3(b), and the sectorial penetration hole 39, shown in FIG. 9, may be formed with a closed end. However, when a part of these penetration holes 20 and 39 has an opening outwardly, the seatbelt 4 can also be thereby inserted through the opening into these penetration holes 20 and 39 with ease. This allows easy insertion for the seatbelt 4 into the penetration holes 20 and 39.

Furthermore, in the above-described embodiment, the tongue retrieval assisting device 10 is attached to the motor vehicle seat 2. However, the present invention is not limited to this configuration and the tongue retrieval assisting device 10 can be also provided in a floor portion of the body of the vehicle, or the like.

A tongue retrieval assisting device and a seatbelt apparatus using the tongue retrieval assisting device is installed on motor vehicles such as an automobile or the like, and is provided for an occupant by fastening the occupant with the seatbelt. This invention is also preferably applicable to the seatbelt apparatus in which the seatbelt is worn by the occupant seated on a motor vehicle seat by inserting and latching the tongue slidably supported by the seatbelt into the buckle fixed on a body of a vehicle.

The priority application, Japanese Patent Application No. 2004-322219 filed on Nov. 5, 2004, is hereby incorporated by reference herein in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A tongue retrieval assisting device for conveying a tongue slidably supported by a seatbelt between a tongue storage position and a tongue retrieval position set in front of an occupant seated on a motor vehicle seat, comprising:
a tongue receiving member for supporting a tongue;
a conveying device for conveying the tongue receiving member and the tongue from the tongue storage position to the tongue retrieval position;
wherein the conveying device is attached to the seat with an elastic mount to buffer forces exerted upon the conveying device.

2. The tongue retrieval assisting device according to claim 1, wherein the elastic mount is a rubber mount.

3. The tongue retrieval assisting device according to claim 1, wherein the conveying device is a telescopically extending.

4. The tongue retrieval assisting device according to claim 1, wherein the rod is formed by a plurality of rod members.

5. The tongue retrieval assisting device according to claim 1, wherein the conveying device is controlled by a controller monitoring signals from a sensor that detects retraction of the conveying device and from a sensor that detects extension of the conveying device.

6. The tongue retrieval assisting device according to claim 1, wherein the tongue retrieval assisting device is controlled by a controller monitoring signals from a sensor that detects whether a door is open and from a sensor that detects if a passenger is in the seat.

7. The tongue retrieval assisting device according to claim 1, further comprising a sensor for detecting the retrieval of the tongue from the tongue receiving member.

8. The tongue retrieval assisting device according to claim 1, wherein the tongue receiving member includes a tongue receiving plate.

9. The tongue retrieval assisting device according to claim 8, wherein the tongue receiving plate is smaller than the tongue.

10. The tongue retrieval assisting device according to claim 8, wherein the tongue receiving plate includes a slot for the seatbelt.

11. The tongue retrieval assisting device according to claim 8, wherein the tongue receiving plate is substantially U-shaped.

12. The tongue retrieval assisting device according to claim 11, wherein the tongue receiving plate includes a sectorial hole for the seatbelt.

13. The tongue retrieval assisting device according to claim 11, wherein the tongue receiving plate includes a sensor for detecting retrieval of the tongue and a hole for the sensor to be positioned in.

14. The tongue retrieval assisting device according to claim 11, wherein the tongue receiving plate has an inverted U-shape;
wherein the tongue receiving plate is adapted to position a portion of the tongue on the top of the tongue receiving plate for retrieval of the tongue.

15. The tongue retrieval assisting device according to claim 1, further comprising a controller for controlling the tongue retrieval assisting device.

16. A seatbelt apparatus comprising:
a seatbelt for an occupant of a seat;
a seatbelt retractor mounted on a motor vehicle for urging the seatbelt in a direction for retracting the seatbelt;
a tongue that is slidably supported by the seatbelt; and
a buckle mounted on the motor vehicle that is latched when the tongue inserted thereinto,
a tongue receiving member for supporting the tongue; and
a conveying device for conveying the tongue receiving member and the tongue between tongue retrieval position and a tongue storage position;
wherein the conveying device is attached to the seat by an elastic mount for buffering forces exerted upon the conveying device.
